(19) United States
(12) Patent Application Publication
(10) Pub. No.: US 2007/0147196 A1
(43) Pub. Date: Jun. 28, 2007

(54) OPTICAL INFORMATION PROCESSING DEVICE

(75) Inventor: Suguru TAKISHIMA, Tokyo (JP)

Correspondence Address: GREENBLUM & BERNSTEIN, P.L.C., 1950 ROLAND CLARKE PLACE, RESTON, VA, 20191, US

(73) Assignee: PENTAX CORPORATION, Tokyo (JP)

(21) Appl. No.: 11/616,056

(22) Filed: Dec. 26, 2006

(30) Foreign Application Priority Data
Dec. 26, 2005 (JP) P2005-372123

(51) Int. Cl. G11B 7/00

(52) U.S. Cl. 369/44.14; 369/44.23

(57) ABSTRACT

An optical information processing device, configured to perform operations of reading and writing information on an optical disk, includes a light source configured to emit a laser beam, an image forming unit configured to converge the laser beam emitted by the light source on the optical disk, a first actuating system configured to actuate the image forming unit so as to converge the laser beam in a desired position on the optical disk, an aberration correcting unit configured to correct aberration generated on a light path from the light source to the optical disk, a second actuating system configured to actuate the aberration correcting unit independently of the image forming unit, and a control system configured to control the second actuating system so as to keep a relative position of the aberration correcting unit with respect to the image forming unit constant.

### BACKGROUND OF THE INVENTION

The present invention relates to an optical information processing device that performs operations of reading and writing information on an optical disk, particularly, to an optical information processing device provided with an imaging means for imaging a laser beam emitted by a light source on the optical disk and an aberration correcting means for correcting aberration of the laser beam caused on a light path from the light source to the optical disk so as to perform the operations of reading and writing information on the optical disk with moving the imaging means such that the laser beam can be converged in a predetermined position on the optical disk.

Recently, next generation optical disks with high recording densities such as a Blu-Ray Disk (BD) and High Definition DVD (HD DVD) are standardized, and there is widely known an optical information processing device adapted to perform operations (such as a reading operation and writing operation) for such high density optical disks. A high NA objective lens is incorporated in such an optical information processing device. In addition, a laser beam with a short wavelength is employed for such an optical information processing device. Thus, by employing the high NA objective lens and the laser beam with the short wavelength, the optical information processing device can form an extremely small beam spot on the optical disk and process high density information on the optical disk.

However, when an objective lens is designed to have a high NA, or when the laser beam with the short wavelength is used, it causes a significant effect of aberration (e.g., spherical aberration) on the beam spot. In other words, aberration caused by a small error has a significant effect on whether a preferred beam spot can be generated. Consequently, the optical information processing device easily causes an error while performing the operations for the optical disk.

Errors at the device side can previously be eliminated by an adjustment work before shipping. Such errors include, for example, a manufacturing error for the objective lens, which can be eliminated, for example, by axial alignment and tilt adjustment for the objective lens.

On the other hand, errors at the optical disk side cannot be eliminated by the adjustment work at the device side. Therefore, the aberration, caused by the aforementioned errors at the optical disk side, induces an undesired beam spot, and thereby the operations for the optical disk might not preferably be performed. It is noted that the errors at the optical disk side include, for example, individual difference of the optical disk, an error and unevenness in recording layer thickness.

In order to solve such a problem, for example, an optical information processing device in which an aberration correcting liquid crystal device is implemented is disclosed in Japanese Patent Provisional Publication No. 2002-56565 (hereinafter, referred to as '565 Publication). According to the optical information processing device disclosed in '565 Publication, a different voltage is applied to each electrode of the liquid crystal device so as to control orientation of each liquid crystal molecule, and thereby the correction of the aberration is attained by shifting a phase of a laser beam transmitted through the liquid crystal device. Errors at the optical disk side are detected when the optical disk is set, and the amount of the phase shift is determined based on the detection result. Hence, the errors at the optical disk can appropriately be eliminated.

Here, as described in '565 Publication, in order to appropriately correct the aberration with the liquid crystal device, a constant positional relationship between the objective lens and the liquid crystal device is required. Therefore, according to '565 Publication, the liquid crystal device is configured as a single unit fixed to the objective lens. In this configuration, since the liquid crystal device is moved integrally with the objective lens, the positional relationship therebetween is always kept constant. Thereby, the preferred aberration correction is attained.

However, the optical information processing device disclosed in '565 Publication causes a larger weight of the unit including the objective lens than a conventional objective lens as a trade-off for the preferred aberration correction attained by adding the liquid crystal device. When the weight of the aforementioned unit is increased, a following response property of the unit goes down. Namely, since a response speed of the unit is worsened, the unit cannot precisely and fast move. In the meantime, associated with higher density and/or a higher rotational speed of the optical disk, a unit that can precisely and fast move is required. For this reason, for the optical information processing device for the optical disk with a high recording density, the increase in the weight of the unit as aforementioned is not desirable.

Further, in the optical information processing device disclosed in '565 Publication, cables for supplying an electrical power to the liquid crystal device have to be added to the unit. It is a factor to reduce flexibility for designing the unit. In this respect, the unit in which the liquid crystal device is implemented is not desirable.

### SUMMARY OF THE INVENTION

The present invention is advantageous in that there can be provided an optical information processing device that can appropriately correct aberration without increasing the weight of a unit including an objective lens and provide high flexibility in design thereof.

According to an aspect of the present invention, there is provided an optical information processing device configured to perform operations of reading and writing information on an optical disk, which includes: a light source configured to emit a laser beam; an image forming unit configured to converge the laser beam emitted by the light source on the optical disk; a first actuating system configured to actuate the image forming unit so as to converge the laser beam in a desired position on the optical disk; an aberration correcting unit configured to correct aberration generated on a light path from the light source to the optical disk; a second actuating system configured to actuate the aberration correcting unit independently of the image forming unit; and a control system configured to control the second actuating system so as to keep a relative position of the aberration correcting unit with respect to the image forming unit constant.

Optionally, the optical information processing device may further include a position detecting system configured to detect a displacement of the image forming unit actuated by the first actuating system from a predetermined position. In this case, the control system may be configured to control the second actuating system based on the displacement of the image forming unit detected by the position detecting system.

Alternatively or optionally, the optical information processing device may further include a relative position detecting system configured to detect a relative position of the aberration correcting unit with respect to the image forming unit. In this case, the control system may be configured to control the second actuating system based on the relative position of the aberration correcting unit with respect to the image forming unit detected by the relative position detecting system.

Optionally, the first actuating system may be configured to actuate the image forming unit in both of a direction perpendicular to the optical disk and a radial direction of the optical disk. Further optionally, the second actuating system may be configured to actuate the aberration correcting unit in the radial direction of the optical disk. In this case, the control system may be configured to control the second actuating system so as to keep a relative position of the aberration correcting unit with respect to the image forming unit in the radial direction of the optical disk constant.

Still optionally, the first actuating system may be configured with a moving coil type of biaxial actuator.

Optionally, the second actuating system may be configured with a moving magnet type of actuator.

Optionally, the aberration correcting unit may be configured with a liquid crystal device.

According to another aspect of the present invention, there is provided an optical information processing device configured to perform operations of reading and writing information on an optical disk, which includes: a light source configured to emit a laser beam; a movable unit configured to be coarsely moved in a radial direction of the optical disk, the movable unit including a image forming unit configured to converge the laser beam emitted by the light source on the optical disk, a first actuating system configured to finely actuate the image forming unit so as to converge the laser beam in a desired position on the optical disk; an aberration correcting unit configured to correct aberration generated on a light path from the light source to the optical disk, and a second actuating system configured to actuate the aberration correcting unit independently of the image forming unit; and a control system configured to control the second actuating system so as to keep a relative position of the aberration correcting unit with respect to the image forming unit constant.

### BRIEF DESCRIPTION OF THE ACCOMPANYING DRAWINGS

FIG. 1A is a perspective view showing a configuration of an optical information processing device in a first embodiment according to the present invention.

FIG. 1B is an assembly drawing of a housing and a drive control circuit included in the optical information processing device in the first embodiment according to the present invention.

FIG. 2 shows configurations of a fixed unit and movable unit provided in the optical information processing device in the first embodiment according to the present invention.

FIG. 3 is a perspective view of the movable unit in the first embodiment according to the present invention.

FIG. 4 is a cross-sectional view of the movable unit in the first embodiment according to the present invention.

FIGS. 5 and 6 are exploded perspective views of constituent elements inside a carriage provided to the movable unit in the first embodiment according to the present invention.

FIG. 7 schematically shows a movable aberration correcting portion and objective lens unit provided to an optical information processing device in a second embodiment according to the present invention.

FIGS. 8A, 8B, 9A, and 9B are illustrations for explaining a position following operation of the movable aberration correcting portion for the objective lens unit in the second embodiment according to the present invention.

### DETAILED DESCRIPTION OF THE EMBODIMENTS

Hereinafter, with reference to the accompanying drawings, a configuration and operation of an optical information processing device in each of embodiments according to the present invention will be described.

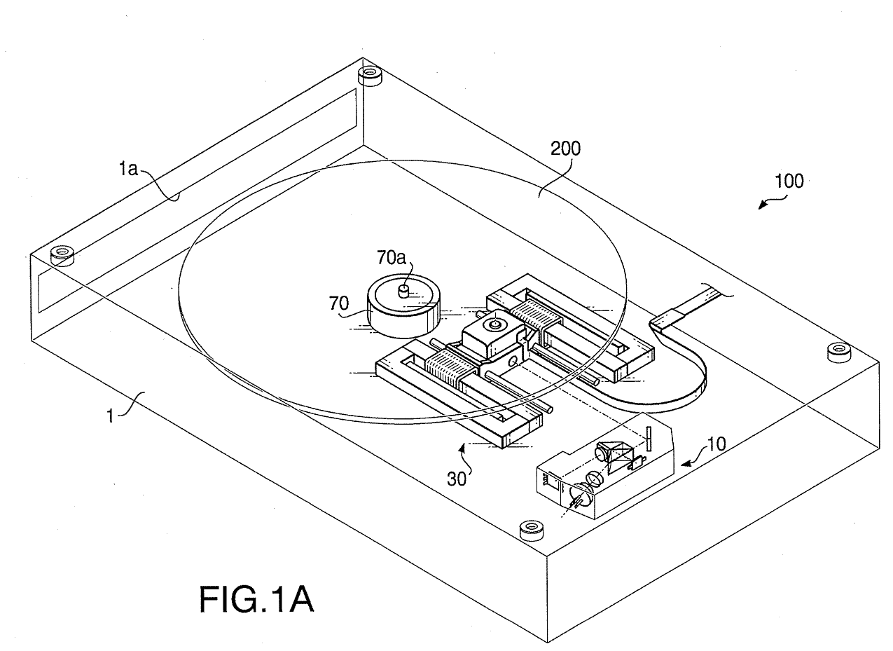

FIG. 1A is a perspective view showing a configuration of an optical information processing device 100 in a first embodiment according to the present invention. FIG. 1B is an assembly drawing of a housing 1 and a drive control circuit 2 included in the optical information processing device 100 in the first embodiment. The housing 1 is formed with a slot 1a. In addition, a tray (not shown) is provided to be put into and ejected from the housing 1 via the slot 1a. It is noted that FIG. 1A shows a state where an optical disk 200 placed on the tray is housed in the housing 1. In the aforementioned state, the optical disk 200 is set on a spindle motor 70. The optical disk is rotated around a rotational axis 70a by the spindle motor 70. It is noted that the optical disk 200 is an optical disk with a high recording density such as a Blu-Ray Disk (BD) and High Definition DVD (HD DVD).

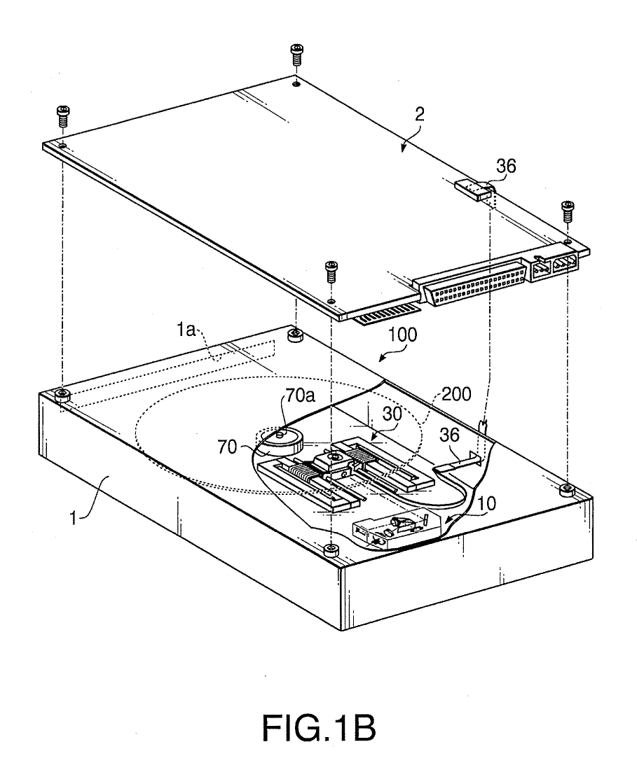

The optical information processing device 100 includes a fixed unit 10 and a movable unit 30. FIG. 2 shows configurations of the fixed unit 10 and movable unit 30. These units are held by the housing 1.

The fixed unit 10 is provided with a laser diode 11, collimator lens 12, first anamorphic prism 13, half mirror 13a, second anamorphic prism 14, mirror 15, rectangular prism 16, hologram element 17, condenser lens 18, compound sensor 19, and laser power monitor sensor 20.

The laser diode 11 emits a diverging laser beam with an oval cross section. The diverging laser beam is a laser beam with a short wavelength (for example, approximately 400 nm). The diverging laser beam emitted by the laser diode 11 is incident onto the collimator lens 12. The collimator lens 12 converts the diverging laser beam emitted by the laser diode 11 into a collimated light beam. The laser beam converted into the collimated light beam is incident onto the first anamorphic prism 13.

The first anamorphic prism 13 and second anamorphic prism 14 form the collimated light beam from the collimator lens 12 into a collimated light beam with substantially a circular cross section. Subsequently, the collimated light beam formed into the collimated light beam with substantially a circular cross section is incident onto the mirror 15. In addition, a portion of the collimated light beam incident onto the first anamorphic prism 13 is bent by the half mirror 13a by 90 degrees, and is then incident onto the laser power monitor sensor 20.

The laser power monitor sensor 20 transmits a signal corresponding to the intensity of the light received thereby to a laser power control circuit (not shown). The laser power control circuit takes feedback control based on the level of the signal received thereby, so as to stabilize the output from the laser diode 11.

On the other hand, the mirror 15 bends the collimated light beam emitted by the second anamorphic prism 14 by 90 degrees. The bent laser beam is emitted by the fixed unit 10, and is then incident onto the movable unit 30.

The movable unit 30 is provided with a carriage 31. The carriage 31 is supported by guide shafts 33R and 33L whose ends are fixed to predetermined positions of the housing 1 so as to be capable of sliding along a radial direction of the optical disk 200 (that is, along a tracking direction indicated with an arrow T in each of accompanying drawings). Further, driving means for moving the movable unit 30 along the tracking direction is provided to sandwich the carriage 31. Specifically, there are provided at a side of the guide shaft 33R a yoke 34R fixed to a predetermined position of the housing 1 and a coil 35R in which the yoke 34R is inserted, while there are provided at a side of the guide shaft 33L a yoke 34L fixed to a predetermined position of the housing 1 and a coil 35L in which the yoke 34L is inserted. In response to the drive control circuit 2 (see FIG. 1B) causing an electrical current to be carried through each of the coils 35R and 35L fixed to the carriage 31, thrust is produced by the electromagnetic action, and thereby the carriage 31 is moved along the tracking direction.

In addition, the carriage 31 includes an opening 31a on a wall portion opposite the fixed unit 10. The laser beam emitted by the fixed unit 10 is incident into the carriage 31 via the opening 31a.

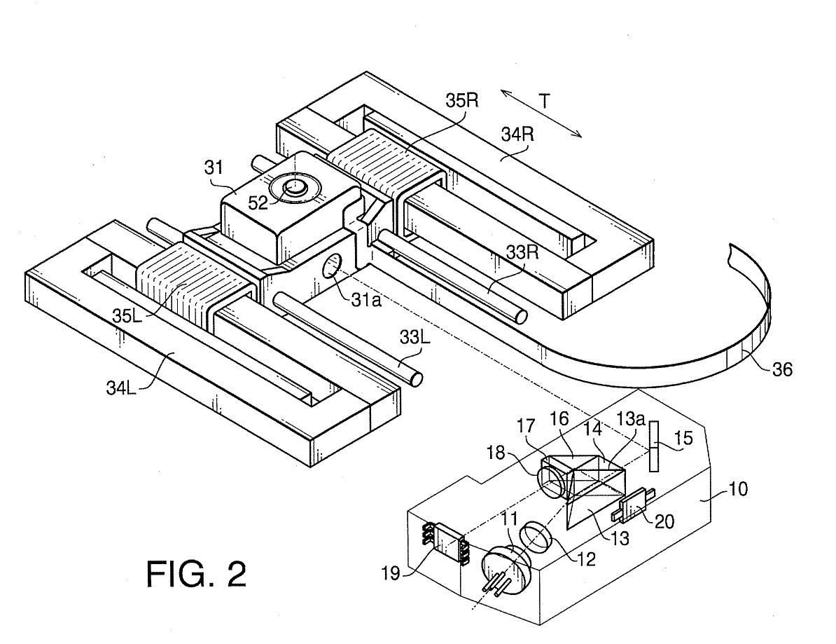

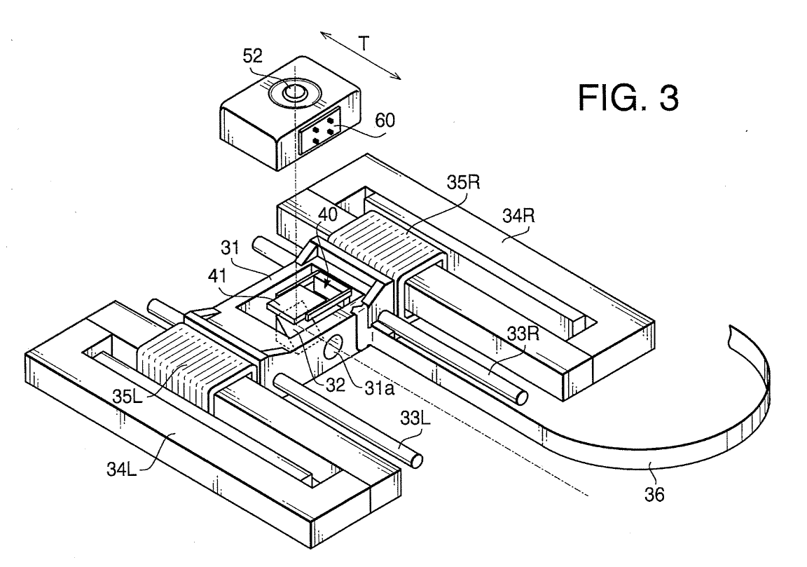

FIG. 3 shows a perspective view of the movable unit 30 with a portion of the carriage 31 being cut off. In addition, FIG. 4 shows a cross-sectional view of the movable unit 30. In FIG. 3, the carriage 31 is shown divided into upper and lower portions for convenience of explanation.

There are provided inside the carriage 31 an upward-directing mirror 32, aberration correcting unit 40, and objective lens unit 50. The laser beam incident into the carriage 31 via the opening 31a is directed in a vertical direction (in a direction perpendicular to a surface of the optical disk 200) by the upward-directing mirror 32. Subsequently, the laser beam is incident onto the aberration correcting unit 40.

The aberration correcting unit 40 is provided with two plate elements, i.e., a liquid crystal aberration correcting element 41 and quarter wavelength plate 42. These elements are attached to a frame 40a, and are laminated in the order of the liquid crystal aberration correcting element 41 and quarter wavelength plate 42 from the side of the upward-directing mirror 32. Accordingly, the laser beam emitted by the upward-directing mirror 32 is firstly incident onto the liquid crystal aberration correcting element 41.

The liquid crystal aberration correcting element 41 is an element with a widely known configuration. The liquid crystal aberration correcting element 41 includes a liquid crystal that provides, to the incident laser beam, a birefringent change caused by an electrical field generated depending on an applied voltage. In other words, in the liquid crystal aberration correcting element 41, an orientation of each of a plurality of liquid crystal molecules, which constitute the liquid crystal, changes due to the electrical field generated depending on the applied voltage. By changing the orientation of each of the plurality of liquid crystal molecules, the birefringent change is provided to the laser beam passing through the plurality of liquid crystal molecules. Consequently, a phase of the laser beam is shifted. Here, the phase shift of the laser beam means a change in the aberration of the laser beam. For this reason, by shifting the phase by an appropriate amount with the liquid crystal aberration correcting element 41, it is possible to correct the aberration (mainly, spherical aberration).

In addition, the liquid crystal aberration correcting element 41 has a plurality of electrodes for generating the electrical field. The plurality of electrodes is arranged in a manner distributed on the liquid crystal aberration correcting element 41. Therefore, when the voltage is applied to each of the electrodes, each of the plurality of liquid crystal molecules distributed on the liquid crystal aberration correcting element 41 is oriented in a direction depending on a voltage applied to each of the plurality of electrodes. By controlling the voltage applied to each of the plurality of electrodes such that each of the plurality of liquid crystal molecules is oriented in an appropriate direction in response to an aberration distribution of the laser beam, the aberration of the laser beam generated on the light path can properly be corrected.

The movable unit 30 includes a flexible board 36 connected with the aforementioned drive control circuit 2. Each of the elements included in the movable unit 30 is operated by a signal inputted via the flexible board 36.

The laser beam transmitted through the liquid crystal aberration correcting element 41 is in a linearly-polarized state. Such a linearly-polarized laser beam is converted into a circularly-polarized laser beam by the quarter wavelength plate 42, and is incident onto the objective lens unit 50.

The objective lens unit 50 is provided with an objective lens holder 51, which holds an objective lens 52. The objective lens 52 is designed to be of a high NA (e.g., NA=0.85). It is noted that positions shown in FIG. 4 of the objective lens 52 and liquid crystal aberration correcting element 41 are respective reference positions. The reference position for the objective lens 52 is a position in the case where an optical axis of the objective lens 52 conforms to an optical axis of the whole optical information processing device 100 (an axis indicated by an alternate long and short dash line in each of accompanying drawings). Meanwhile, the reference position for the liquid crystal aberration correcting element 41 is a position in the case where a center 41c of the liquid crystal aberration correcting element 41 is present on the optical axis of the whole optical information processing device 100.

The laser beam emitted by the liquid crystal aberration correcting element 41 and quarter wavelength plate 42 is incident onto the objective lens 52, and is converged on the optical disk 200 as a microscopic beam spot. It is noted that the optical disk 200 includes a thin film recording layer 200a and disk substrate 200b on which information is recorded. More accurately, the aforementioned beam spot is formed on the recording layer 200a.

Namely, the laser beam emitted by the objective lens 52 is converged on the optical disk 200 with the aberration being corrected by operations of the optical elements and liquid crystal aberration correcting element 41. Next, the laser beam is reflected by the optical disk 200. The laser beam reflected by the optical disk 200 is incident to the fixed unit 10 as a return light beam via the movable unit 30. Thereafter, the return light beam is bent by the mirror 15 by 90 degrees, and is directed to the second anamorphic prism 14. The return light beam transmitted through the second anamorphic prism 14 is bent by the half mirror 13a by 90 degrees, and is incident onto the rectangular prism 16 and hologram element 17.

The hologram element 17 is a light dividing element. In the embodiment, the hologram element 17 divides the return light beam incident via the rectangular prism 16 into three light beams directed in different directions. The three light beams into which the return light beam is divided are incident onto the compound sensor 19 via the condenser lens 18.

The compound sensor 19 is provided with a light receiving element for servo control and light receiving element for data (both not shown). These light receiving elements are arranged along a line of the three light beams into which the return light beam is divided by the hologram element 17. One of the three light beams is received by the light receiving element for data, and arithmetic processing is performed for it as an information signal of the optical disk 200.

The other two light beams of the three light beams are received by the light receiving element for servo control. Arithmetic processing is performed for output signals from the light receiving element for servo control by an arithmetic processing portion (not shown), and the processed output signals are detected as a focus error signal and tracking error signal. Based on each of the error signals, a biaxial actuator of the objective lens unit is driven to make a fine adjustment for the position of the objective lens 52 such as tracking control.

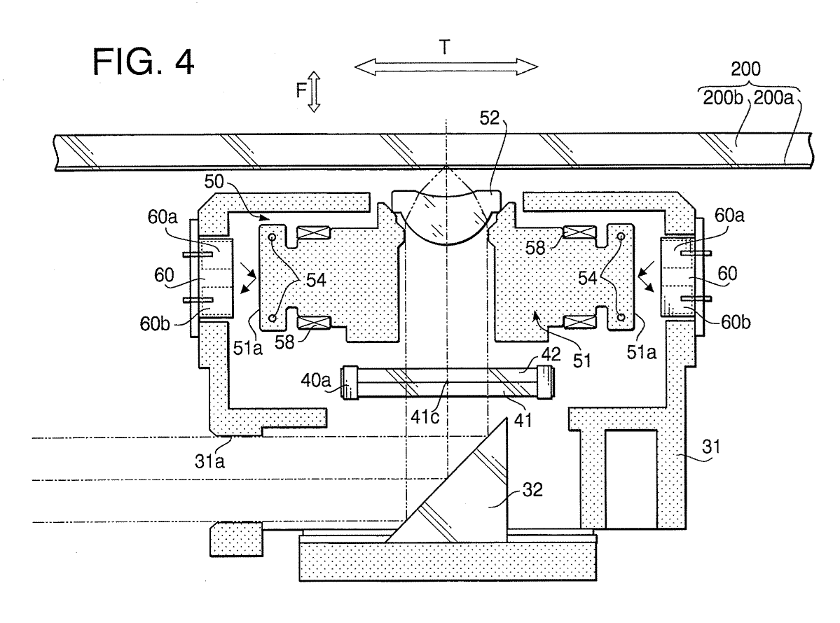

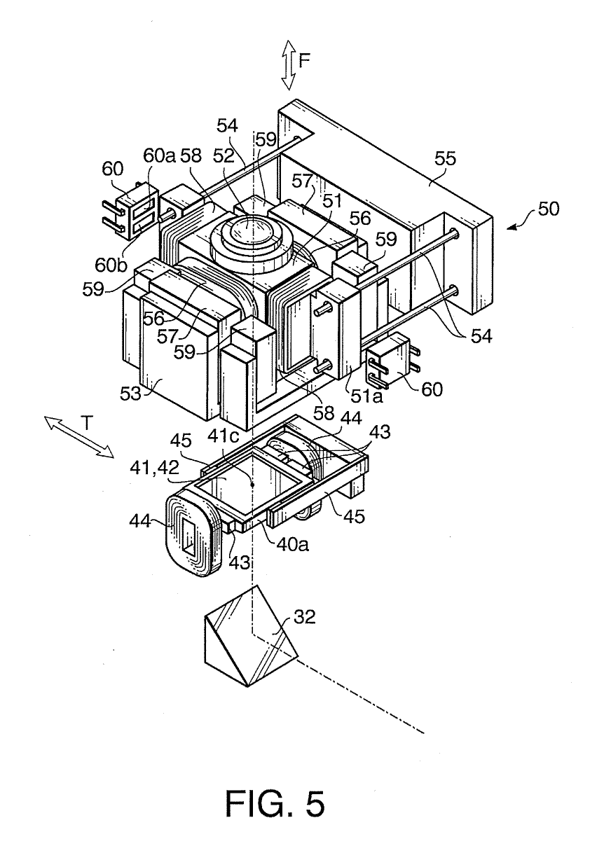

Here, the biaxial actuator of the objective lens unit 50 will be described. FIGS. 5 and 6 show exploded perspective views of constituent elements inside the carriage 31. There is employed as the biaxial actuator of the objective lens unit 50 a so-called moving coil type of biaxial actuator with a mechanism where coils move.

The objective lens unit 50 includes, as well as the objective lens holder 51 and objective lens 52, an actuator base 53, wires 54, a wire fixing block 55, focus coils 56, focus magnets 57, tracking coils 58, and tracking magnets 59.

The actuator base 53 is held by the carriage 31. The objective lens holder 51 is movably mounted on the actuator base 53. A pair of focus coils 56 is wound around the objective lens holder 51 such that the objective lens 52 is sandwiched therebetween in a direction perpendicular to the arrow T. In addition, a pair of tracking coils 58 is wound around the objective lens holder 51 such that the objective lens 52 is sandwiched therebetween in the direction of the arrow T.

Further, two wires 54 are attached to each of both ends of the objective lens holder 51. One end of each of the wires 54 is attached to the objective lens holder 51, while the other end is attached to the wire fixing block 55 held by the carriage 31. In addition, the wires 54 are formed, for example, from conductive material. An electrical current is supplied to each of the focus coils 56, and tracking coils 58 via the wires 54 by the drive control circuit 2.

Four focus magnets 57 are fixed to the actuator base 53. Two of the focus magnets 57 are arranged at each of both sides of the objective lens holder 51 such that the objective lens holder 51 is sandwiched between two focus magnets 57 at one side of the objective lens holder 51 and the other two focus magnets 57 at the other side in the direction perpendicular to the arrow T. In addition, at each of the both sides of the objective lens holder 51 in the direction perpendicular to the arrow T, the two focus magnets 57 are placed side by side in a direction of an arrow F (namely, in a focusing direction that is perpendicular to a surface of the optical disk 200). A corresponding one of the focus coils 56 is placed close to each of the focus magnets 57.

When an electrical current is supplied to each of the focus coils 56, the objective lens holder 51 is moved by a thrust (repulsive force or attractive force) generated between a magnetic force generated by the electrical current supplied to the focus coil 56 and a magnetic force by the focus magnet 57 placed close to the focus coil 56. At this time, the objective lens holder 51 is translated, bending the wires 54, only along the focusing direction (namely, along the direction of the arrow F) due to a positional relationship between the focus coils 56 and the focus magnets 57. A translation range is defined from a position where the objective lens holder 51 is mounted on the actuator base 53 to a position where the thrust is identical to a restoring force of the wires 54. A distance by which the objective lens holder 51 is to be moved in the focusing direction is determined based on the aforementioned focus error signal. The objective lens 52 can form a preferred beam spot on the optical disk 200 by such a focusing operation.

In addition, four tracking magnets 59 are fixed to the actuator base 53. Two of the tracking magnets 59 are arranged at each of both sides of the objective lens holder 51 such that the objective lens holder 51 is sandwiched between two tracking magnets 59 at one side of the objective lens holder 51 and the other two tracking magnets 59 at the other side in the direction of the arrow T. In addition, at each of the both sides of the objective lens holder 51 in the direction perpendicular to the arrow T, the two tracking magnets 59 are placed side by side to sandwich the focus magnet 57 in the direction of the arrow T. A corresponding one of the tracking coils 58 is placed close to each of the tracking magnets 59.

When an electrical current is supplied to each of the tracking coils 58, the objective lens holder 51 is moved by a thrust generated between a magnetic force generated by the electrical current supplied to the tracking coil 58 and a magnetic force by the tracking magnet 59 placed close to the tracking coil 58. At this time, the objective lens holder 51 is translated, bending the wires 54, only along the tracking direction (namely, along the direction of the arrow T) due to a positional relationship between the tracking coils 58 and the tracking magnets 59. A translation range is defined by a position where the thrust is identical to a restoring force of the wires 54. A distance by which the objective lens holder 51 is to be moved in the tracking direction is determined based on the aforementioned tracking error signal. The objective lens 52 can form a beam spot in an appropriate position on the optical disk 200 by such a tracking operation.

It is noted that, in a state where no electrical current is supplied to each of the focus coils 56 and tracking coils 58 (namely, when the actuator is not driven), the objective lens unit 50 is placed in the aforementioned reference position (that is, in the position shown in FIG. 4).

In the embodiment, in order to reduce the weight of the objective lens holder 51, the objective lens holder 51 is formed as a resin molded product made of a so-called engineering plastic. Accordingly, each of the focus coils 56 and tracking coils 58 functions as a hollow coil.

It is noted that the objective lens unit 50 further includes a pair of widely known reflective photo-interrupters 60. Each of the photo-interrupters 60 is provided with a light projecting portion 60a that projects light and a light receiving portion 60b that receives the projected light. Each of the reflective photo-interrupters 60 is set to face a corresponding one of the wall portions 51a.

Each of the wall portions 51a of the objective lens holder 51 includes a plane reflective surface to reflect the light projected by the light projecting portion 60a. In response to the reflected light being received by the light receiving portion 60b, a signal depending on a light intensity change proportional to a distance to the reflective surface is generated and transmitted to the aforementioned drive control circuit 2. The drive control circuit 2 detects a displacement of the objective lens unit 50 with respect to the aforementioned reference position in the tracking direction based on the signal from each of the reflective photo-interrupters 60. A control technique for the displacement detection is disclosed in Japanese Utility Model Publication No. HEI 5-21331 by the applicant.

Next, the aberration correcting unit 40 will be explained in detail. In the embodiment, in order to reduce the weight of the objective lens unit 50, the objective lens unit 50 and aberration correcting unit 40 are configured as units independent from one another.

Firstly, a configuration of the aberration correcting unit 40 will be described. In a direction perpendicular to the arrows T and F, two of magnets 43 for driving the liquid crystal are attached to each of both side surfaces of the frame 40a. In addition, on each of the side surfaces of the frame 40a in the direction perpendicular to the arrows T and F, the two of the magnets 43 for driving the liquid crystal are arranged side by side in the direction of the arrow T.

In the direction perpendicular to the arrows T and F, a pair of coils 44 for driving the liquid crystal is placed such that the liquid crystal aberration correcting element 41 is sandwiched therebetween, and such that each of the coils 44 for driving the liquid crystal is located close to corresponding two of the magnets 43 for driving the liquid crystal. The coils 44 for driving the liquid crystal are held by the carriage 31. In addition, the coils for driving the liquid crystal are hollow coils, and are connected with the aforementioned drive control circuit 2.

Further, the liquid crystal aberration correcting element 41 and quarter wavelength plate 42 are griped between a pair of plate springs 45 extending in the direction perpendicular to the arrows T and F. One end of each of the plate springs 45 is held by the carriage 31. Electrical power supply to the liquid crystal aberration correcting element 41 is made, for example, using patterned electrodes formed on the plate springs 45.

Next, an operation of the aberration correcting unit 40 will be described. It is noted that there is employed for the aberration correcting unit 40 a so-called moving magnet type of actuator with a mechanism where magnets move.

When an electrical current is supplied to each of the coils 44 for driving the liquid crystal, members including the magnets for driving the liquid crystal, the frame 40a, liquid crystal aberration correcting element 41, and quarter wavelength plate 42 are moved by a thrust generated between a magnetic force generated by the electrical current supplied to the coil 44 for driving the liquid crystal and a magnetic force by the magnet 43 for driving the liquid crystal placed close to the coil 44 for driving the liquid crystal. At this time, the members are translated, bending the plate springs 45, only along the tracking direction (namely, along the direction of the arrow T) due to a positional relationship between the magnets 43 for driving the liquid crystal and the coils 44 for driving the liquid crystal. A translation range is defined by a position where the thrust is identical to a restoring force of the plate spring 45. For convenience of explanation, the members moved by the thrust, i.e., the magnets for driving the liquid crystal, the frame 40a, liquid crystal aberration correcting element 41, and quarter wavelength plate 42 are referred to as a “movable aberration correcting portion 40M”.

In a state where no electrical current is supplied to each of the coils 44 for driving the liquid crystal (namely, when the actuator is not driven), the movable aberration correcting portion 40M is located in the aforementioned reference position.

The moving distance of the movable aberration correcting portion 40M in the tracking direction is determined based on the aforementioned displacement of the objective lens unit 50 detected by the reflective photo-interrupters 60.

Namely, the aforementioned drive control circuit 2 firstly calculates the displacement of the objective lens unit 50 with respect to the reference position in the tracking direction, i.e., positional information on the position of the objective lens unit 50. Secondly, based on the calculated positional information, a value of an electrical current to be supplied to each of the coils 44 for driving the liquid crystal is determined. When the electrical current thus configured is supplied to each of the coils 44 for driving the liquid crystal, each of the plate springs 45 is bent by the thrust generated. Thereby, the movable aberration correcting portion 40M is moved such that the optical axis of the objective lens unit 50 conforms to the center 41c of the liquid crystal aberration correcting element 41 in the tracking direction. Namely, there is performed a position following operation of the movable aberration correcting portion 40M to follow the position of objective lens unit 50.

The position following operation of the movable aberration correcting portion 40M for the objective lens unit 50 is always performed. Therefore, the optical axis of the objective lens unit 50 always conforms to the center 41c of the liquid crystal aberration correcting element 41 in the tracking direction. Since the positional relationship between the objective lens unit 50 and the liquid crystal aberration correcting element 41 is always constant, the aberration correcting operation of the liquid crystal aberration correcting element 41 is always and preferably performed.

In the first embodiment, with the objective lens unit 50 and the aberration correcting unit 40 being configured as units independent from one another, it is attained to reduce the weight of the objective lens unit 50. Thereby, a following response property of the objective lens unit 50 in the tracking direction of the optical disk 200 is improved. In other words, a response speed of the objective lens unit 50 is improved, so that the objective lens unit 50 can precisely and fast move. Thereby, there can be provided an optical information processing device that is sufficiently able to meet requirements for a high recording density and a high rotational speed of the optical disk.

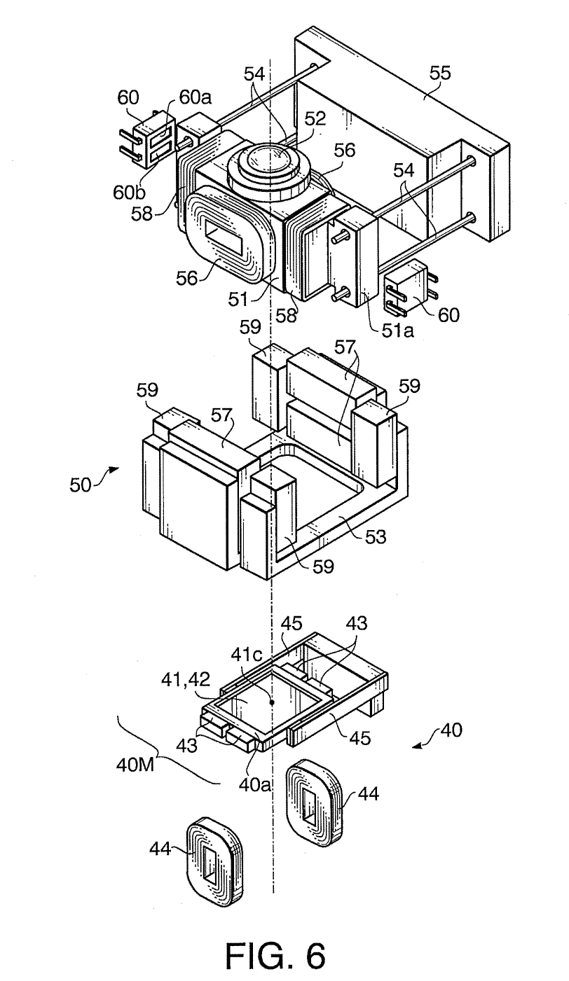

Next, an optical information processing device in a second embodiment according to the present invention will be explained. FIG. 7 schematically shows a movable aberration correcting portion 40M′ and objective lens unit 50′ provided to an optical information processing device in a second embodiment. It is noted that, in the following explanation for the second embodiment, to configurations that are the same as or similar to the optical information processing device 100 in the first embodiment, reference signs that are the same as or similar to the first embodiment are given, and explanation regarding them will be omitted here. For the sake of simple drawings, configurations that are not necessary for the explanation of the second embodiment will not be shown in each of drawings. For example, although the wires 54 are not shown in FIG. 7, the objective lens unit 50′ is actually provided with the wires 54.

In addition, for convenience of explanation, reference signs “O₁”, and “O₂” are given to the optical axis of the objective lens 52 and an axis that passes through the center 41c of the liquid aberration correcting device 41 and is parallel to the optical axis “O₁”, respectively. In a state where the optical axis “O₁” conforms to the axis “O₂” (that is, in a state shown in FIG. 7), the liquid crystal aberration correcting device 41 can preferably correct the aberration.

In the second embodiment, a pair of widely known reflective photo-interrupters 61 is implemented on the frame 40a such that the liquid crystal aberration correcting device 41 is sandwiched therebetween. Namely, the movable aberration correcting portion 40M′ is configured to add the pair of reflective photo-interrupters 61 to the movable aberration correcting portion 40M. Each of the photo-interrupters 61 is provided with a light projecting portion 61a that projects light and a light receiving portion 61b that receives the projected light. Each of the reflective photo-interrupters 61 is set to be close to and face a corresponding one of wall portions 51b.

On a surface of each of the wall portions 51b, there is provided a variable reflective film configured such that the reflectance gradually varies (increases or decreases) as getting away from the optical axis “O₁”. The reflectance properties of the wall portions 51b are symmetric with respect to the optical axis “O₁”. Therefore, in the state where the optical axis “O₁” conforms to the axis “O₂”, light projected by each of the light projecting portions 61a is incident onto a portion with substantially the same reflectance on a corresponding one of the wall portions 51b. Hence, an intensity of reflected light received by the light receiving portion 61b of each of the reflective photo-interrupters 61 is substantially the same. In this case, since an output intensity of each of the reflective photo-interrupters 61 is the same, the difference between the output intensities of both of the reflective photo-interrupters 61 is zero. With the aforementioned drive control circuit 2 taking servo control such that the difference between the output intensities of both of the reflective photo-interrupters 61 is zero, the position following operation of the movable aberration correcting portion 40M′ for the objective lens unit 50′ is performed.

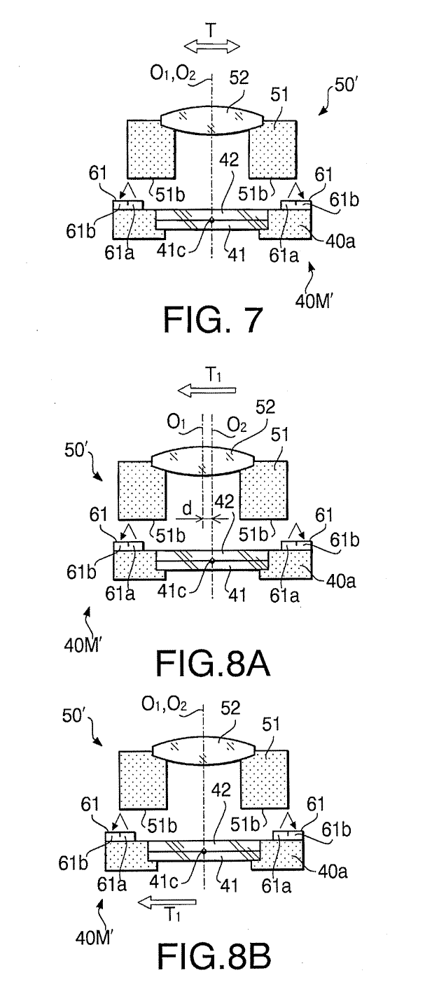

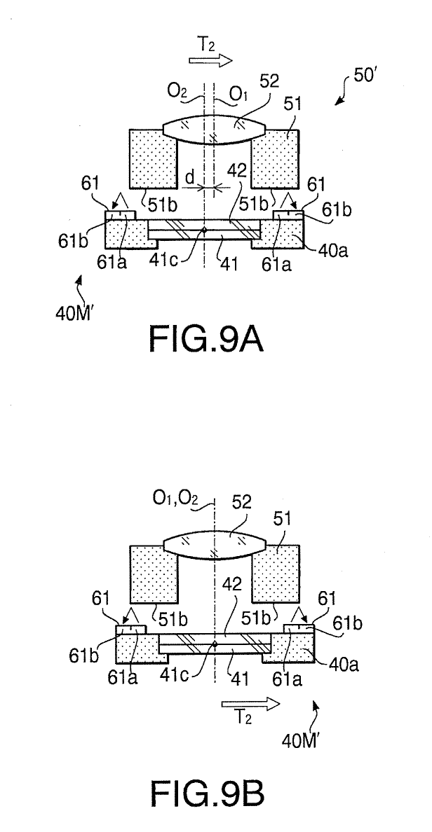

FIGS. 8A, 8B, 9A, and 9B are drawings for explaining the position following operation of the movable aberration correcting portion 40M′ for the objective lens unit 50′ in the second embodiment. For example, as shown in FIG. 8A, when the objective lens unit 50′ moves by a distance d from the position shown in FIG. 7 in a direction T₁ along the tracking direction, the aforementioned drive control circuit 2 controls the movable aberration correcting portion 40M′ to follow the objective lens unit 50′ based on the output of each of the reflective photo-interrupters 61.

More specifically, the drive control circuit 2 obtains the output intensity of each of the reflective photo-interrupters 61. Secondly, the drive control circuit 2 calculates the difference between the obtained output intensities of the reflective photo-interrupters 61. In a state as shown in FIG. 8A, each of the light projecting portions 61a projects the light onto a portion with a different reflectance. For this reason, each of the reflective photo-interrupters 61 obtains a different output intensity. Therefore, the difference between the output intensities is not zero. The drive control circuit 2 judges that the positional relationship between the objective lens unit 50′ and movable aberration correcting portion 40M′ deviates from an ideal positional relationship (i.e., the state shown in FIG. 7), and takes the servo control for the movable aberration correcting portion 40M′ to move in the tracking direction such that the difference between the output intensities is zero. Namely, the movable aberration correcting portion 40M′ is moved until it is in a state shown in FIG. 8B. In this manner, the position following operation of the movable aberration correcting portion 40M′ for the objective lens unit 50′ is attained.

In addition, FIG. 9A shows a state where the objective lens unit 50′ is moved from the position shown in FIG. 7 by a distance d in a direction T₂ along the tracking direction (an opposite direction of the direction T₁). In this case, in the same manner as the example shown in FIGS. 8A and 8B, with the drive control circuit 2 taking the servo control such that the difference between the output intensities of the reflective photo-interrupters 61 is zero, the position following operation of the movable aberration correcting portion 40M′ for the objective lens unit 50′ is performed. Namely, the movable aberration correcting portion 40M′ is controlled to move until it is in a state shown in FIG. 9B.

In the second embodiment, in the same manner as the first embodiment, since the objective lens unit 50′ and aberration correcting unit (movable aberration correcting portion 40M′) are configured as units independent from one another, respectively, the weight of the objective lens unit 50′ can be reduced. Thereby, the following response property of the objective lens unit 50′ in the tracking direction of the optical disk 200 is improved.

It is noted that, in the second embodiment, since the position following operation of the movable aberration correcting portion 40M′ for the objective lens unit 50′ is performed by the servo control, a positional following operation with a higher accuracy can be attained.

Hereinabove, the embodiments according to the present invention have been described. The present invention is not limited to the embodiments, and various sorts of modifications may be possible as far as they are within a technical scope which does not extend beyond a subject matter of the present invention. For example, although the actuators of the moving coil type and moving magnet type are employed in the embodiments, other types of actuators may be applied.

Further, for example, by making the carriage 31 support the quarter wavelength plate 42, the movable aberration correcting portion 40M′ may be configured without the quarter wavelength plate 42. In this case, since the weight of the movable aberration correcting portion 40M′ is further reduced, the position following property of the movable aberration correcting portion 40M′ for the objective lens unit 50′ is more improved.

Further, in the second embodiment, the center of the light projected by each of the light projecting portions 61a may be directed to an edge portion of a corresponding one of the wall portions 51b. In this case, accompanied by the movement of the wall portions 51b (that is, the objective lens unit 50′), an area of a corresponding one of the wall portions 51b illuminated by the light projected by each of the light projecting portions 61 varies. Therefore, difference is caused between the intensities of the light received by the light receiving portions 61b of both of the reflective photo-interrupters 61. Consequently, output difference is caused between both of the reflective photo-interrupters 61, and based on the output difference, the moving distance of the objective lens unit 50′ with respect to the aberration correcting unit is calculated. In this case, the wall portions 51b may be configured as uniform reflective surfaces without the variable reflective film.

The present disclosure relates to the subject matter contained in Japanese Patent Application No. P2005-372123, filed on Dec. 26, 2005, which is expressly incorporated herein by reference in its entirety.

What is claimed is:

1. An optical information processing device configured to perform operations of reading and writing information on an optical disk, comprising:
a light source configured to emit a laser beam;
an image forming unit configured to converge the laser beam emitted by the light source on the optical disk;
a first actuating system configured to actuate the image forming unit so as to converge the laser beam in a desired position on the optical disk;
an aberration correcting unit configured to correct aberration generated on a light path from the light source to the optical disk;
a second actuating system configured to actuate the aberration correcting unit independently of the image forming unit; and
a control system configured to control the second actuating system so as to keep a relative position of the aberration correcting unit with respect to the image forming unit constant.

2. The optical information processing device according to claim 1, further comprising a position detecting system configured to detect a displacement of the image forming unit actuated by the first actuating system from a predetermined position,
wherein the control system is configured to control the second actuating system based on the displacement of the image forming unit detected by the position detecting system.

3. The optical information processing device according to claim 1, further comprising a relative position detecting system configured to detect a relative position of the aberration correcting unit with respect to the image forming unit,
wherein the control system is configured to control the second actuating system based on the relative position of the aberration correcting unit with respect to the image forming unit detected by the relative position detecting system.

4. The optical information processing device according to claim 1,
wherein the first actuating system is configured to actuate the image forming unit in both of a direction perpendicular to the optical disk and a radial direction of the optical disk,
wherein the second actuating system is configured to actuate the aberration correcting unit in the radial direction of the optical disk, and
wherein the control system is configured to control the second actuating system so as to keep a relative position of the aberration correcting unit with respect to the image forming unit in the radial direction of the optical disk constant.

5. The optical information processing device according to claim 4,
wherein the first actuating system is configured with a moving coil type of biaxial actuator.

6. The optical information processing device according to claim 4,
wherein the second actuating system is configured with a moving magnet type of actuator.

7. The optical information processing device according to claim 1,
wherein the aberration correcting unit is configured with a liquid crystal device.

8. An optical information processing device configured to perform operations of reading and writing information on an optical disk, comprising:
a light source configured to emit a laser beam;
a movable unit configured to be coarsely moved in a radial direction of the optical disk, the movable unit including:
an image forming unit configured to converge the laser beam emitted by the light source on the optical disk;
a first actuating system configured to finely actuate the image forming unit so as to converge the laser beam in a desired position on the optical disk;
an aberration correcting unit configured to correct aberration generated on a light path from the light source to the optical disk; and
a second actuating system configured to actuate the aberration correcting unit independently of the image forming unit; and
a control system configured to control the second actuating system so as to keep a relative position of the aberration correcting unit with respect to the image forming unit constant.

9. The optical information processing device according to claim 8, further comprising a position detecting system configured to detect a displacement of the image forming unit actuated by the first actuating system from a predetermined position,
wherein the control system is configured to control the second actuating system based on the displacement of the image forming unit detected by the position detecting system.

10. The optical information processing device according to claim 8, further comprising a relative position detecting system configured to detect a relative position of the aberration correcting unit with respect to the image forming unit,
wherein the control system is configured to control the second actuating system based on the relative position of the aberration correcting unit with respect to the image forming unit detected by the relative position detecting system.

11. The optical information processing device according to claim 8,
wherein the first actuating system is configured to actuate the image forming unit in both of a direction perpendicular to the optical disk and the radial direction of the optical disk,
wherein the second actuating system is configured to actuate the aberration correcting unit in the radial direction of the optical disk, and
wherein the control system is configured to control the second actuating system so as to keep a relative position of the aberration correcting unit with respect to the image forming unit in the radial direction of the optical disk constant.

12. The optical information processing device according to claim 11,
wherein the first actuating system is configured with a moving coil type of biaxial actuator.

13. The optical information processing device according to claim 11,
wherein the second actuating system is configured with a moving magnet type of actuator.

14. The optical information processing device according to claim 8,
wherein the aberration correcting unit is configured with a liquid crystal device.
